(19) United States
(12) Patent Application Publication
(10) Pub. No.: US 2005/0288016 A1
(43) Pub. Date: Dec. 29, 2005

(54) Subscription based equivalent lists in wireless communications networks

(76) Inventors: Ravi Kuchibhotla, Gurnee, IL (US); Niels Peter Skov Andersen, Roskilde (DK); Stephen A. Howell, Gloucester (GB)

Correspondence Address: MOTOROLA INC, 600 NORTH US HIGHWAY 45, ROOM AS437, LIBERTYVILLE, IL, 60048-5343, US

(21) Appl. No.: 10/875,669

(22) Filed: Jun. 24, 2004

(51) Int. Cl. H04Q 7/20

(52) U.S. Cl. 455/435.2; 455/435.1

(57) ABSTRACT

A wireless communications device send a communication 302, for example, a registration request, to a communications network, and then receives a message 304 from the network, for example, a registration reject message, in response to the communication sent. In one embodiment, the message received from the network includes information identifying a network portion, for example, one or more location areas to which the wireless communications device is prohibited from registering. In one embodiment, multiple prohibited location areas are identified as a range of location areas.

### FIELD OF THE DISCLOSURE

The present disclosure relates generally to communications networks, and more particularly to communications between wireless communications devices and wireless communications networks having divided into logical portions, for example, multiple location areas, messages and methods.

### BACKGROUND OF THE DISCLOSURE

Public Land Mobile Network (PLMN) wireless communications networks generally comprise one or more location areas, which are defined arbitrarily by the network operator. A location area (LA) generally comprises a plurality of cells controlled by a Base Station Controller (BSC) which itself is within a Mobile Switching Center (MSC) service area in the PLMN.

Wireless communications network operators generally control network access on a Public Land Mobile Network (PLMN) or a Location Area (LA) basis or both. 3GPP TS 22.011, 23.122 and 24.008 describe network registration procedures and TS 24.008 describes the procedure for the network to reject mobile stations on an individual location area basis during a registration attempt. For example, the network can send the mobile station a registration rejection requiring the mobile station to search for another suitable cell in a different location area within the same PLMN.

Typically any new communications network is rolled out in a phased manner. For example, the rollout of 3^{rd} Generation (3G) wireless communications networks is being performed in a phased manner that will create islands of 3G service areas in a sea of 2G networks. Meanwhile, 3G network operators will provide access to 2G networks until 3G networks are deployed in all areas. While many network operators rolling out newer 3G network services have already deployed 2G networks, other 3G network operators do not have 2G spectrum licenses.

3G network operators without 2G licenses must rely on roaming agreements with 2G network operators in order to provide contiguous service for subscribers. A 2G/3G network operator having a roaming agreement to provide service to subscribers of 3G only operators however will want to exclude the 3G only operators' subscribers from using the 3G portion of its network.

The 3GPP specifications recognize the concept of Equivalent PLMNs, whereby a mobile terminal is provided an indication of which PLMNs are to be considered as equivalent for the purpose of network registration. Mobile terminals receive the equivalent PLMN list on successful completion of the location update procedures. However, if the PLMN identity of both the 3G and 2G networks of the same operator are identical, then a roaming mobile terminal cannot be sent a location update reject indicating that the PLMN is forbidden, since the 2G network would also then become forbidden to the roaming subscriber.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary wireless communications network.

FIG. 2 is an exemplary wireless communications network supporting 2^{nd} and 3^{rd} generation communications protocols.

FIG. 3 is an exemplary communications diagram between a communications device and a network.

### DETAILED DESCRIPTION

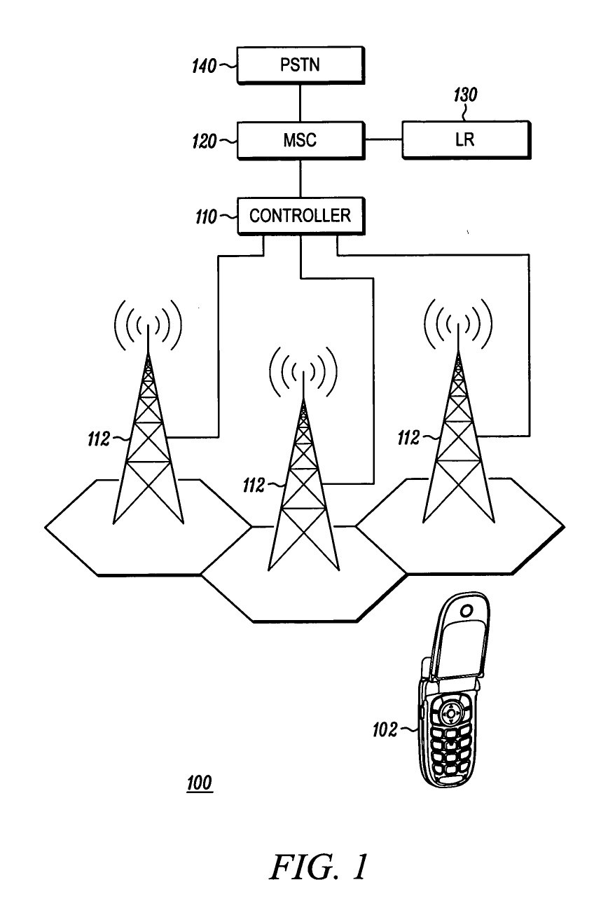

In FIG. 1, the exemplary wireless communications system 100, for example, a public land mobile network (PLMN), comprises generally a common access network including a controller 110 communicably coupled to one or more cellular area transceivers 112 that communicate with communication devices, for example, the wireless mobile station (MS) 102, in the corresponding cells. In Global System for Mobile Communications (GSM) networks, the access network is a Radio Access Network (RAN) including a Base Station Controller (BSC) communicably coupled to one or more Base Transceiver Systems (BTS). In Universal Mobile Telecommunications System (UMTS) 3G W-CDMA communications networks, the access network is a Radio Network Subsystem (RNS) including a radio network controller (RNC) communicably coupled to a one or more Node Bs. In other embodiments, the access network may also comprise wireless local area network access points, for example, IEEE 802.11 access points, among other access networks points providing connectivity between communication devices and network entities.

In FIG. 1, the wireless communications system 100 also comprises generally a core network communicably coupled to the common access network. In the exemplary core network includes a mobile switching center (MSC) 120 communicably coupled to a location register 130, for example, to a visitor location register (VLR) and/or a home location register (HLR). The exemplary core network may be a GSM network or UMTS 3G network. Other core networks capable of sharing a common radio access network, for example, CDMA 2000 networks and other existing and future wireless communication network protocols, may comprise other network entities and architectures.

In FIG. 1, the exemplary mobile switching center 120 is also communicably coupled to a public switched telephone network (PSTN) 140, for example, by a gateway mobile switching center not illustrated but known by those having ordinary skill in the art. The controller 110 may also be communicably coupled to other networks, for example, to a packet network. In GSM communications networks, for example, the controller may be coupled to a general packet radio service (GPRS) network by a serving GPRS support node (SGSN), also known by those having ordinary skill in the art. The exemplary core network may be a GSM network or UMTS 3G network.

Generally, the communications system or PLMN may comprise multiple core network entities each of which is coupled to multiple radio access networks. In some communications systems or PLMNS, multiple core network entities share the same radio access network or networks and its corresponding radio spectrum. For example, different service providers may operate different core networks identified by corresponding core network identities, for example, by a corresponding Public Land Mobile Network (PLMN) identity (ID), sharing one or more common access networks.

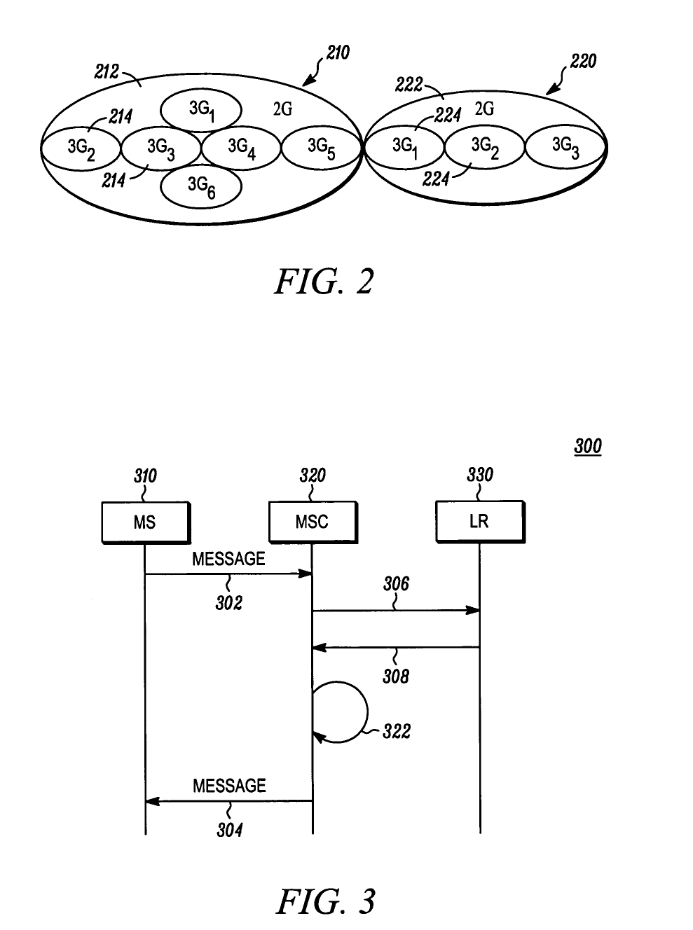

As technology advances, it is common for communications networks to support different communications technologies or protocols, wherein newer generation technologies are compatible with older legacy technologies. In FIG. 2, neighboring wireless communications systems 210 and 220 both support 2^{nd} and 3^{rd} generation wireless communications technologies or protocols. Particularly, in FIG. 2, the systems 210 and 220 are characterized by corresponding contiguous coverage area 212 and 222, respectively, supported by 2^{nd} generation communications technology. The systems 210 and 220 of FIG. 2 also include comparatively isolated coverage areas 214 and 224, respectively, supported by 3^{rd} generation communications technology. In FIG. 2, portions of the PLMN are supported by neighboring 3^{rd} generation coverage areas, while other portions of the PLMN are support only the 2^{nd} generation communications technology.

Wireless communications systems are often divided into multiple smaller location areas defined by relatively small operational coverage areas, for example, multiple cellular coverage areas. The network operators are free to define location areas in any desired manner. In one embodiment, the communications technology is one of the criteria used to define location areas. In FIG. 2, for example, location areas may be defined such that each location area supports either 2^{nd} generation or 3^{rd} generation technology, but not both technologies. Thus at a relatively high level, location areas are distinguished logically by communications technology. The location areas may be further defined as operational portions of the communications system, or PLMN, supported by the different communications technologies. For example, in PLMN 210, the service area supported by 3G1 may be defined as Location Area 1 (LA1), the service area supported by 3G1, 3G3, 3G4 and 3G6 may be defined as LA2, etc. The service area supported by the 2^{nd} generation technology may also be divided into location areas. The PLMN 220 is similarly divided into different location areas. In other embodiments, a location area may support multiple technologies. For example, some location areas may support only 2^{nd} generation communications technology whereas other location areas support both 2^{nd} and 3^{rd} generation communications technologies.

In some applications, it may be desirable to limit roaming agreements by or to particular communications technologies. For example, a 3G network operators without a 2G license must rely on roaming agreements with 2G network operators in order to provide contiguous service for its subscribers, since 3G service is not yet fully deployed in all geographic areas. A 2G/3G network operator having a roaming agreement with a 3G only operator however may want to exclude the 3G only operator's subscribers from using the 3G portion of the 2G/3G operator's network.

Consider two wireless communications network operators A and B. Operator A has only 3G networks, and operator B has 2G/3G networks. Operator A would like a roaming agreement for use of the 2G network of operator B. Operator B would however like to prohibit 3G subscribers of operator A from accessing the 3G network of operator B.

Generally, network access may be prohibited to roaming mobile subscriber terminals either on PLMN or location area basis using the registration procedure. Particularly, when a terminal attempts to register on a PLMN, the terminal may either be accepted or rejected with a cause value. Some cause values allow the entire PLMN to be indicated as forbidden and so stored on the communications device, for example, in a subscriber identification module (SIM). In some embodiments, a mobile subscriber may have a regional subscription and may therefore have restricted access privileges to different location areas of a PLMN, i.e., certain location areas can be forbidden whereas other are not. A network operator having both 2G and 3G networks may preclude roaming on its 3G networks by defining location areas based on technology, as discussed above. If a roaming mobile terminal attempts to register in a forbidden location area, e.g., some or all 3G location areas of operator B, the network of operator B may reject the registration attempt by sending a registration reject message. The roaming mobile will then select another location area and again attempt registration. However, the registration attempt will be rejected again if roaming mobile selects another forbidden location area. In some applications, the additional signaling associated with failed register attempts is undesirable.

In some embodiments, an equivalent list of location area identities can be provided to the mobile individually identifying each and every prohibited location area. The list may identify only prohibited location areas or permissible location areas. The 3GPP specifications recognize the concept of Equivalent PLMNs, whereby a mobile terminal is provided an indication of which PLMNs are to be considered as equivalent for the purpose of registration. The equivalent list concept can be extended in the specifications to apply to location areas as well, through individual listing of all the permitted or prohibited location areas. In some applications, however, long lists identifying permitted or prohibited location areas may unduly increase the size of the message, for example, the registration reject message that transports the list. Thus in some embodiments, it may be desirable for the message from the network to identify a range of permitted or prohibited location areas, thereby reducing the message size and speeding up the process of successful registration.

In one embodiment, a mobile communications device sends a communication to a communications network, and in response the communications device receives from the network a message including information identifying at least one of a network portion to which the wireless communications device is prohibited from attaching, or a network portion to which the wireless communications device is permitted to attach.

In the exemplary communications diagram 300 of FIG. 3, the mobile terminal or station (MS) 310 sends a message 302 to a mobile switching center (MSC) 320 or equivalent entity. In one embodiment, the message is an attachment request, for example, a registration request, message. In other embodiments or applications, the message 302 sent by the wireless communications device to the network is a message other than an attachment request.

In embodiments where the mobile station or terminal 310 attempts to connect or attach to the network, generally, the terminal sends a connection or attachment request, which may include the identity of the device, e.g., an MSID, location area information. A communications specification specifies the protocol, criteria and procedures for connecting to any particular network.

In FIG. 3, the wireless communications device receives a message 304 from the network in response to sending the attachment request. In embodiments where the message from the wireless communications device is an attach request, the network response message may includes an attach rejection, for example, a registration reject, message. In one embodiment, the message from the network includes information identifying the one or more network portions to which the wireless communications device is permitted to attach or is prohibited from attaching.

In one embodiment, the message received from the network includes information identifying one or more network location areas to which the wireless communications device is prohibited from attaching. In the exemplary roaming agreement between a 3G only network operator and a 2G/3G network operator, the prohibited location areas could be those supported by 3G communications technology in the 2G/3G operator's network. In another embodiment, the message received from the network includes identifies a range of location areas where the wireless communications device is prohibited from attaching. In some embodiments, upon receiving information identifying portions of the network to which the terminal is prohibited from attaching, the terminal does not attempt to attach or register in the portions of the network identified in the message, thereby reducing network traffic that would otherwise result from unsuccessful attempts to attach to the network. In other embodiments, upon receiving information identifying portions of the network to which the terminal is allowed attaching, the terminal attempts to attach or register only in the portions of the network identified in the message, thereby reducing network traffic that would otherwise result from unsuccessful attempts to attach to the network.

In one embodiment, when the network receives an attachment request from the terminal, the network identifies any portions of the communications network where terminal operable within the communications network is or is not permitted to attach or register. In FIG. 3, for example, the mobile switching center 320 sends a request 306 for subscriber information from a location register, for example, from a Visitor Location Register (VLR). The subscriber information indicates the privileges of the terminal attempting to attach to the network. In the exemplary 2G/3G roaming agreement, for example, the subscription information would indicate whether the terminal attempting to attach to the network has 3G network privileges. In FIG. 3, the LR 330 sends a message 308 indicating with subscription information to the MSC 320 in response to the request 306. Generally, the network, for example, the MSC 320 in FIG. 3, generates 322 the message including the identification of the location areas where the terminal does or doe not have access privileges based on any available subscription information, for example, the information obtained from the LR 330. The message is then transmitted to the wireless communications device at 304 as discussed above.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a wireless communications device, the method comprising:
sending a communication from the wireless communications device to a communications network;
receiving a message, from the network, at the wireless communications device in response to the communication sent to the network,
the message received from the network including information identifying at least one of
a network portion to which the wireless communications device is prohibited from attaching, or
a network portion to which the wireless communications device is permitted to attach.

2. The method of claim 1,
sending the communication from the wireless communications device to a communications network includes sending an attachment request,
receiving the message from the network in response to sending the attachment request.

3. The method of claim 2,
receiving the message from the network in response to sending the attachment request includes receiving an attach rejection message,
the attach rejection message including the information identifying at least one of
a network portion to which the wireless communications device is prohibited from attaching, or
a network portion to which the wireless communications device is permitted to attach.

4. The method of claim 1,
receiving the message from the network includes receiving a message identifying at least one network location area to which the wireless communications device is prohibited from attaching.

5. The method of claim 1,
receiving the message from the network includes receiving a message identifying at least two network location areas to which the wireless communications device is prohibited from attaching.

6. The method of claim 1,
receiving the message from the network includes receiving a message identifying a range of location areas where the wireless communications device is prohibited from attaching.

7. The method of claim 1,
receiving the message from the network includes receiving a message identifying at least one network location area to which the wireless communications device is permitted to attach.

9. A method in a wireless communications device, the method comprising:
sending a message from the wireless communications device to a communications network;
receiving a network message, from the network, at the wireless communications device in response to the message sent to the network,
the message received from the network including identifying at least two location areas of the communications network to which the wireless communications device is prohibited to attaching.

10. A method in a wireless communications device, the method comprising:
receiving an attachment rejection message from a network,
the attachment rejection message identifying portions of the network where the wireless communications device is prohibited from attaching;
not attempting to register in the network locations identified in the message.

11. A method in a wireless communications device, the method comprising:
receiving an attachment accept message from a network,
the attachment accept message identifying portions of the network where the wireless communications device is allowed to attach;
attempting to attach only in the network locations identified in the message.

12. A method in a wireless communications network, the method comprising:
identifying at least one portion of the wireless communications network where a wireless communications device operable within the wireless communications network is or is not permitted to attach;
generating a message identifying the at least one portion of the wireless communications network where the wireless communications device is or is not permitted to attach.

13. The method of claim 12,
identifying the at least one portion of the wireless communications network includes identifying at least one location area where the wireless communications device is or is not permitted to attach;
generating the message includes identifying in the message the at least one location area where the wireless communications device is or is not permitted to attach.

14. The method of claim 12, transmitting the message to the wireless communications device.

15. The method of claim 12,
identifying the at least one portion of the wireless communications network includes identifying at least two network location areas where the wireless communications device is or is not permitted to attach;
generating the message includes identifying in the message the at least two network location areas where the wireless communications device is or is not permitted to attach.

16. A method in a wireless communications network, the method comprising:
receiving a message, from a wireless communications device, at the wireless communications network;
generating a message identifying at least one operational area of the wireless communications network where the wireless communications device is not permitted to attach.

17. The method of claim 16,
identifying the at least one operational area of the wireless communications network where the wireless communications device is not permitted to attach in response to receiving the message from the wireless communications device.

18. The method of claim 17,
identifying the at least one operational area of the wireless communications network where the wireless communications device is not permitted to attach includes obtaining subscription information for the wireless communications device,
generating the message identifying at least one operational area of the wireless communications network where the wireless communications device is not permitted to attach.

19. The method of claim 16,
sending the message identifying the at least one operational area of the wireless communications network where the wireless communications device is not permitted to attach after generating the message.

20. The method of claim 16,
receiving the message at the wireless communications network includes receiving an attachment request from the wireless communications device,
generating the message identifying at least one operational area of the wireless communications network where the wireless communications device is not permitted to attach in response to receiving the attachment request.
